(19) United States
(12) Patent Application Publication
(10) Pub. No.: US 2023/0199598 A1
(43) Pub. Date: Jun. 22, 2023

(54) WIRELESS COMMUNICATION DEVICE AND WIRELESS COMMUNICATION METHOD

(71) Applicant: NIPPON TELEGRAPH AND TELEPHONE CORPORATION, Tokyo (JP)

(72) Inventors: Mitsuki NAKAMURA, Musashino-shi, Tokyo (JP); Wataru YAMADA, Musashino-shi, Tokyo (JP); Yasuhiko INOUE, Musashino-shi, Tokyo (JP); Shoko SHINOHARA, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/927,521

(22) PCT Filed: May 28, 2020
(86) PCT No.: PCT/JP2020/021170

§ 371 Date: Nov. 23, 2022

(51) Int. Cl. H04W 36/30; H04W 24/02; H04W 72/542; H04B 17/318

(52) U.S. Cl. CPC H04W 36/30; H04W 24/02; H04W 72/542; H04B 17/318; H04W 16/14

(57) ABSTRACT

A radio communication apparatus according to an embodiment includes a first radio communication unit (1011) that transmits a radio signal by using a first channel, a second radio communication unit (1021) that transmits a radio signal by using a second channel different from the first channel, a first radio information acquisition unit (1013) that acquires first radio information containing received signal strength in the first radio communication unit and usage of the first channel, a second radio information acquisition unit (1023) that acquires second radio information containing received signal strength in the second radio communication unit and usage of the second channel, a determination unit (104) that determines whether to switch between the first radio communication unit and the second radio communication unit in accordance with the first radio information and the second radio information, and a switching unit (105) that switches between the first radio communication unit and the second radio communication unit in accordance with a result of determination by the determination unit.

### TECHNICAL FIELD

Embodiments relate to a radio communication apparatus and a radio communication method.

### BACKGROUND ART

Using a plurality of frequency bands from a low frequency band to a high frequency band, in an unlicensed band, which requires no license enables large-capacity communication in the high frequency band but causes a large propagation loss during communication to an over-the horizon region, communication affected by a shielding object, and long distance communication. In addition, the low frequency band enables long-distance communication but can often cause the communication capacity to be smaller than that in the high frequency band.

Although the unlicensed band is a frequency band easily available to anyone, its resources cannot be managed. In addition, constantly and simultaneously using a plurality of frequencies increases power consumption.

### CITATION LIST

### Patent Literature

PTL 1: JP 2017-143460 A

### Non Patent Literature

NPL 1: Tomotsugu HASEGAWA et al, “Relations of RSSI and Average Throughput of IEEE802.11n Wireless LAN System”, Information Processing Society of Japan, Vol. 52, No. 9, pp. 2829-2840 (September 2011)

### SUMMARY OF THE INVENTION

### Technical Problem

The embodiments, which have been made in view of the above circumstances, provide a radio communication apparatus and a radio communication method capable of stable large-capacity communication with less power consumption.

### Means for Solving the Problem

A radio communication apparatus according to an embodiment includes a first radio communication unit, a second radio communication unit, a first radio information acquisition unit, a second radio information acquisition unit, a determination unit, and a switching unit. The first radio communication unit transmits a radio signal by using a first channel. The second radio communication unit transmits a radio signal by using a second channel different from the first channel. The first radio information acquisition unit acquires first radio information containing received signal strength in the first radio communication unit and usage of the first channel. The second radio information acquisition unit acquires second radio information containing received signal strength in the second radio communication unit and usage of the second channel. The determination unit determines whether to switch between the first radio communication unit and the second radio communication unit in accordance with the first radio information and the second radio information. The switching unit switches between the first radio communication unit and the second radio communication unit in accordance with a result of determination by the determination unit.

### Effects of the Invention

The embodiments allow for providing a radio communication apparatus and a radio communication method capable of stable large-capacity communication with less power consumption.

### BRIEF DESCRIPTION OF DRAWINGS

FIG. 1 is a diagram illustrating an example of a configuration of a radio system according to an embodiment.

FIG. 2 is a diagram illustrating an example of a configuration of a base station.

FIG. 3 is a diagram illustrating an example of a configuration of a terminal.

FIG. 4 is a diagram illustrating an example of a functional configuration of the base station.

FIG. 5 is a diagram illustrating an example of a functional configuration of the terminal.

FIG. 6 is a flowchart illustrating an example of an operation of the base station.

FIG. 7 is a diagram illustrating an example of a MAC frame format of a channel switching request.

FIG. 8 is a flowchart illustrating an example of an operation of the terminal.

FIG. 9 is a diagram illustrating an example of a MAC frame format of a Request Accepted response or a Request Rejected response.

### DESCRIPTION OF EMBODIMENTS

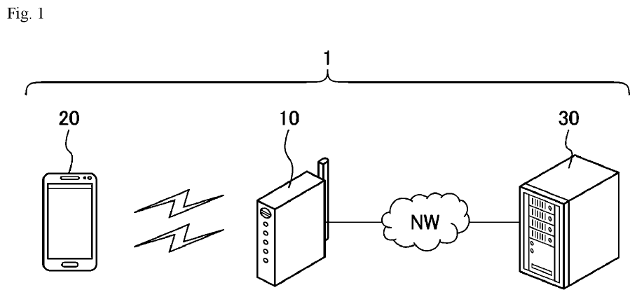

Embodiments will be described below with reference to the drawings. FIG. 1 illustrates an example of a configuration of a radio system 1 according to an embodiment. As illustrated in FIG. 1, the radio system 1 includes a base station 10, a terminal 20, and a server 30, for example.

The base station 10 is a radio communication apparatus that is connected to a network NW and is used as an access point for radio LAN. The base station 10 can transmit, by radio, data received from the network NW to the terminal 20. The base station 10 may be connected to the terminal 20 by using a plurality of different channels. Communication between the base station 10 and the terminal 20 is based on the IEEE 802.11 standard, for example.

The terminal 20 is a radio communication apparatus such as a smartphone and a tablet PC. The terminal 20 can transmit and receive data to and from the server 30 on the network NW via the base station 10 connected by radio. The terminal 20 may be another electronic device such as a desktop computer or a laptop computer. It is only required that the terminal 20 is communicable with at least the base station 10.

The server 30 can hold various information, and holds, for example, content data for the terminal 20. For example, the server 30 is connected to the network NW by wire and is configured to be communicable with the base station 10 via the network NW. It is only required that the server 30 is communicable with at least the base station 10. That is, the communication between the base station 10 and the server 30 may be wired communication or radio communication.

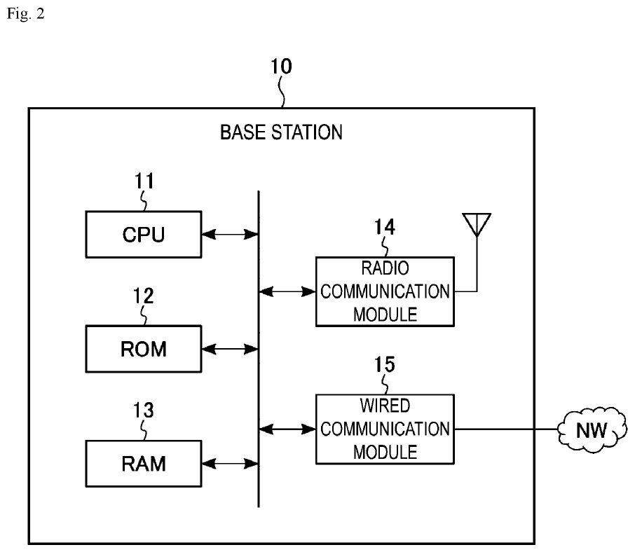

FIG. 2 illustrates an example of a configuration of the base station 10. As illustrated in FIG. 2, for example, the base station 10 includes a central processing unit (CPU) 11, a read only memory (ROM) 12, a random access memory (RAM) 13, a radio communication module 14, and a wired communication module 15.

The CPU 11 is a circuit capable of executing various programs and controls an overall operation of the base station 10. An ASIC or the like may be used instead of the CPU. In addition, the number of CPUs 11 may not be one and may be two or more. The ROM 12 is a non-volatile semiconductor memory, and holds a program, control data, and the like for controlling the base station 10. The RAM 13 is, for example, a volatile semiconductor memory and is used as a work area of the CPU 11. The radio communication module 14 is a circuit used for transmitting and receiving data by a radio signal and is connected to an antenna. The radio communication module 14 includes, for example, a plurality of communication modules respectively corresponding to a plurality of frequency bands. The wired communication module 15 is a circuit used for transmitting and receiving data by a wired signal, and is connected to the network NW.

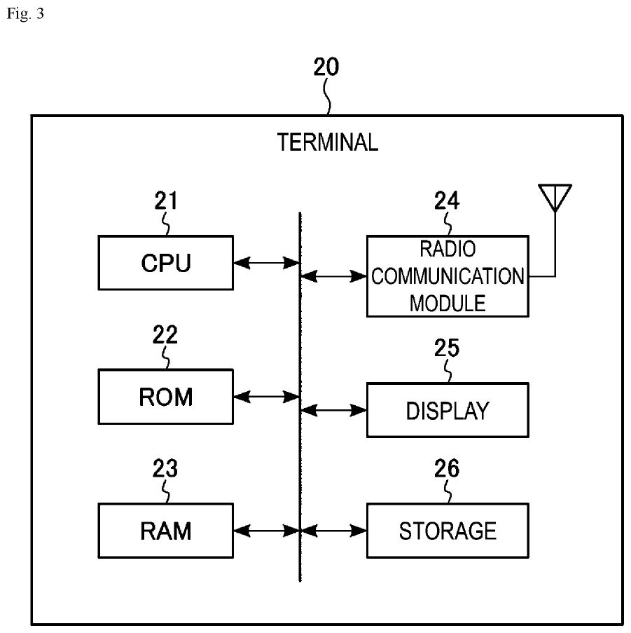

FIG. 3 illustrates an example of a configuration of the terminal 20. As illustrated in FIG. 3, for example, the terminal 20 includes a CPU 21, a ROM 22, a RAM 23, a radio communication module 24, a display 25, and a storage 26.

The CPU 21 is a circuit capable of executing various programs and controls an overall operation of the terminal 20. An ASIC or the like may be used instead of the CPU. In addition, the number of CPUs 21 may not be one and may be two or more. The ROM 22 is a non-volatile semiconductor memory, and holds a program, control data, and the like for controlling the terminal 20. The RAM 23 is, for example, a volatile semiconductor memory and is used as a work area of the CPU 21. The radio communication module 24 is a circuit used for transmitting and receiving data by a radio signal and is connected to an antenna. The radio communication module 24 includes, for example, a plurality of communication modules respectively corresponding to a plurality of frequency bands. The display 25 displays a graphical user interface (GUI) or the like corresponding to application software. The display 25 may have a function as an input interface of the terminal 20. The storage 26 is a nonvolatile storage device and holds system software and the like of the terminal 20.

The radio system 1 performs data communication based on an open systems interconnection (OSI) reference model, for example. In the OSI reference model, a communication function is divided into seven layers (first layer: physical layer, second layer: data link layer, third layer: network layer, fourth layer: transport layer, fifth layer: session layer, sixth layer: presentation layer, seventh layer: application layer). The data link layer includes, for example, a logical link control (LLC) layer and a media access control (MAC) layer. In the present specification, the third layer to the seventh layer are referred to as “higher layers” based on the data link layer.

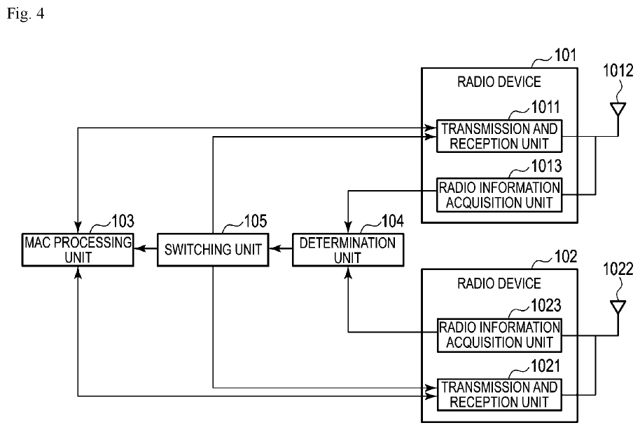

FIG. 4 illustrates an example of a functional configuration of the base station 10. As illustrated in FIG. 4, the base station 10 includes, for example, radio devices 101 and 102, a MAC processing unit 103, a determination unit 104, and a switching unit 105. The radio devices 101 and 102, the MAC processing unit 103, the determination unit 104, and the switching unit 105 are realized by, for example, the CPU 11 and the radio communication module 14.

Each of the radio devices 101 and 102 performs processing related to transmission and reception of a radio signal. The radio device 101 and the radio device 102 handle radio signals of different channels. The radio device 101 handles, for example, a radio signal in a 2.4 GHz band. The radio device 102 handles a radio signal in a frequency band higher than the frequency band of the radio device 101, for example, a 5 GHz band. In the embodiment, the radio device 101 and the radio device 102 may be used simultaneously. In addition, the radio device 101 and the radio device 102 may also be used exclusively. Furthermore, in FIG. 4, two radio devices are provided. Three or more radio devices may be provided in the base station 10.

The radio device 101 includes a transmission and reception unit 1011, an antenna 1012, and a radio information acquisition unit 1013. The radio device 102 includes a transmission and reception unit 1021, an antenna 1022, and a radio information acquisition unit 1023.

When transmitting a radio signal, the transmission and reception unit 1011 as a first radio communication unit performs processing of a first layer (physical layer) on a MAC frame input from the MAC processing unit 103 to generate a radio signal and transmits the radio signal to the terminal 20 via the antenna 1012. When receiving a radio signal, the transmission and reception unit 1011 performs the processing of the first layer on the radio signal received from the terminal 20 via the antenna 1012 to restore the MAC frame, and outputs the MAC frame to the MAC processing unit 103. Similarly, when transmitting a radio signal, the transmission and reception unit 1021 as a second radio communication unit performs processing of a first layer on a MAC frame input from the MAC processing unit 103 to generate a radio signal and transmits the radio signal to the terminal 20 via the antenna 1022. When receiving a radio signal, the transmission and reception unit 1021 performs the processing of the first layer on the radio signal received from the terminal 20 via the antenna 1022 to restore the MAC frame, and outputs the MAC frame to the MAC processing unit 103.

The antennas 1012 and 1022 are antennas including antenna elements for transmitting and receiving radio signals. Each of the antennas 1012 and 1022 may include a single antenna element or a plurality of antenna elements. In FIG. 4, the antennas 1012 and 1022 are separately provided for each radio device. Only one of the antenna 1012 and the antenna 1022 may be provided, and this one antenna may be shared by two radio devices.

The radio information acquisition unit 1013 acquires first radio information. The first radio information contains the received signal strength (RSSI) in the transmission and reception unit 1011 and usage of a channel of the transmission and reception unit 1011. The radio information acquisition unit 1023 acquires second radio information. The second radio information contains the received signal strength (RSSI) in the transmission and reception unit 1021 and usage of a channel of the transmission and reception unit 1021. Here, the RSSI represents the reception strength of the radio signal received by the transmission and reception unit. The RSSI is measured from, for example, reception strength of a response signal from the terminal 20 to a beacon signal broadcasted from the base station 10. In addition, the RSSI may be measured from, for example, reception strength of a response signal from the terminal 20 to a request signal periodically transmitted from the base station 10 to the specific terminal 20. The usage of the channel may be measured from the communication time of the communication performed at the respective transmission and reception unit with respect to the maximum communicable time defined between the base station 10 and the terminal 20.

The MAC processing unit 103 may perform processing of the second layer (data link layer). When transmitting a radio signal, the MAC processing unit 103 performs the processing of the second layer on data transferred from the server 30 or the like to generate a MAC frame, and outputs the MAC frame to the radio device 101 or the radio device 102. In addition, when receiving a radio signal, the MAC processing unit 103 performs the processing of the second layer on the MAC frame transferred from the radio device 101 or the radio device 102 to restore data.

The determination unit 104 determines whether switching of the channel in communication of a radio signal, that is, switching of the radio device is performed. The determination unit 104 outputs the result of the determination to the switching unit 105. The determination unit 104 compares the RSSI acquired by each of the radio devices 101 and 102 to a threshold value and determines whether switching of the channel is performed in accordance with the comparison result. The determination unit 104 compares the throughput in the currently used channel to a threshold value and determines whether the switching of the channel is performed in accordance with the comparison result. Details of the determination unit 104 will be described later.

The switching unit 105 performs switching of the channel in accordance with the result of the determination of the determination unit 104. The switching of the channel may be performed by switching a hardware switch or may be performed by switching by software.

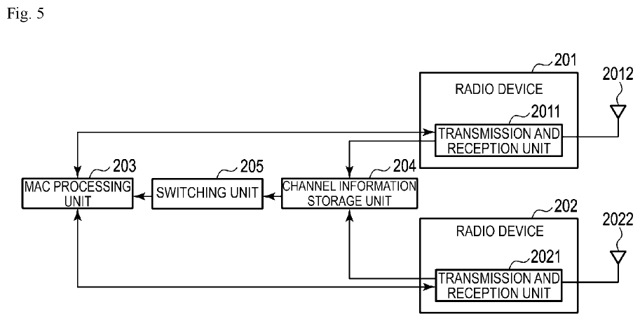

FIG. 5 illustrates an example of a functional configuration of the terminal 20. As illustrated in FIG. 5, the terminal 20 includes, for example, radio devices 201 and 202, a MAC processing unit 203, a channel information storage unit 204, and a switching unit 205. The radio devices 201 and 202, the MAC processing unit 203, and the switching unit 205 are realized by, for example, the CPU 21 and the radio communication module 24. The channel information storage unit 204 is realized by, for example, the ROM 22 or the RAM 23.

Each of the radio devices 201 and 202 performs processing related to transmission and reception of a radio signal. The radio device 201 handles a radio signal in the same channel as the radio device 101. The radio device 201 handles, for example, a radio signal in a 2.4 GHz band. The radio device 202 handles a radio signal in the same channel as the radio device 102. The radio device 202 handles, for example, a radio signal in a 5 GHz band. In the embodiment, the radio device 201 and the radio device 202 may be used simultaneously. In addition, the radio device 201 and the radio device 202 may also be used exclusively. Furthermore, in FIG. 5, two radio devices are provided. Three or more radio devices may be provided in the terminal 20.

The radio device 201 includes a transmission and reception unit 2011 and an antenna 2012. The radio device 202 includes a transmission and reception unit 2021 and an antenna 2022.

When transmitting a radio signal, the transmission and reception unit 2011 performs processing of a first layer (physical layer) on a MAC frame input from the MAC processing unit 203 to generate a radio signal and transmits the radio signal to the base station 10 via the antenna 2012. In addition, when receiving a radio signal, the transmission and reception unit 2011 performs the processing of the first layer on the radio signal received from the base station 10 via the antenna 2012 to restore the MAC frame, and outputs the MAC frame to the MAC processing unit 203. Similarly, when transmitting a radio signal, the transmission and reception unit 2021 performs processing of the first layer on a MAC frame input from the MAC processing unit 203 to generate a radio signal and transmits the radio signal to the base station 10 via the antenna 2022. In addition, when receiving a radio signal, the transmission and reception unit 2021 performs the processing of the first layer on the radio signal received from the base station 10 via the antenna 2022 to restore the MAC frame, and outputs the MAC frame to the MAC processing unit 203.

The antennas 2012 and 2022 are antennas including antenna elements for transmitting and receiving radio signals. Each of the antennas 2012 and 2022 may include a single antenna element or a plurality of antenna elements. In FIG. 5, the antennas 2012 and 2022 are separately provided for each radio device. Only one of the antenna 2012 and the antenna 2022 may be provided, and this one antenna may be shared by two radio devices.

The MAC processing unit 203 may perform processing of the second layer (data link layer). When transmitting a radio signal, the MAC processing unit 103 performs the processing of the second layer on data transferred from the higher layer such as an application layer to generate a MAC frame, and outputs the MAC frame to the radio device 201 or the radio device 202. In addition, when receiving a radio signal, the MAC processing unit 203 performs the processing of the second layer on the MAC frame transferred from the radio device 201 or the radio device 202 to restore data.

The channel information storage unit 204 stores information on a channel to be used. The switching unit 205 switches the channel in accordance with the information on the channel, which is stored in the channel information storage unit 204. The switching of the channel may be performed by switching a hardware switch or may be performed by switching by software.

In the functional configuration of the radio system 1 described above, the radio devices 101 and 102 of the base station 10 are configured to be connectable to the radio devices 201 and 202 of the terminal 20, respectively. Specifically, the radio devices 101 and 201 may be connected to each other by radio by using, for example, a 2.4 GHz band channel. The radio devices 102 and 202 may be connected to each other by radio by using, for example, a 5 GHz band channel.

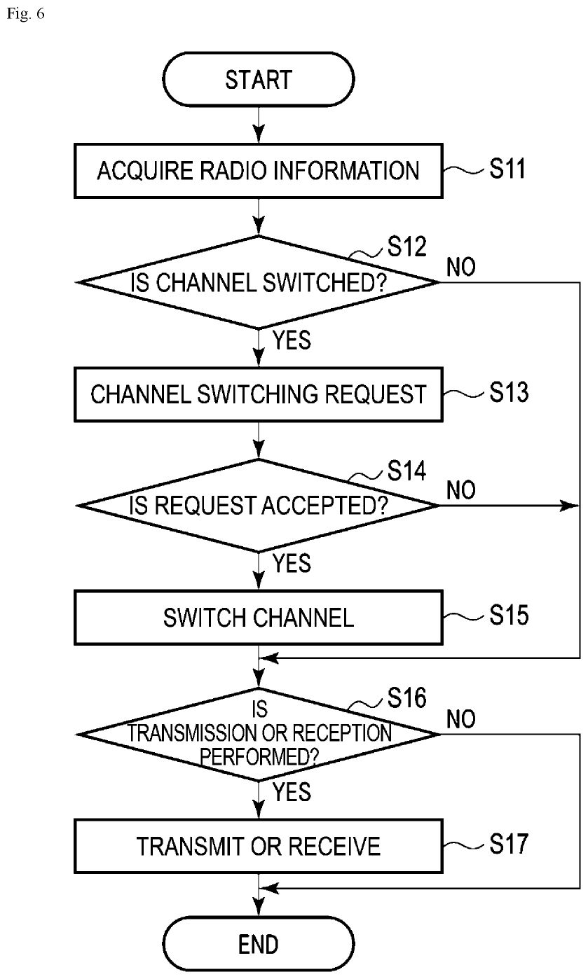

Next, an operation of the radio communication system 1 will be described. First, the operation of the base station 10 will be described. FIG. 6 is a flowchart illustrating an example of the operation of the base station 10. In Step S11, the base station 10 acquires first radio information and acquires second radio information. As described above, the RSSI as radio information is measured from, for example, the reception strength of a response signal from the terminal 20, to a beacon signal. The response signal includes a terminal identifier for identifying the terminal 20. Since the terminal 20 is distinguished by the terminal identifier, the number of terminals 20 using the channel of the radio device 101 and the number of terminals 20 using the channel of the radio device 102 may be specified. In addition, the RSSI may be measured from, for example, reception strength of a response signal from the terminal 20 to a request signal periodically transmitted from the base station 10 to the specific terminal 20. The usage of the channel may be measured from the communication time of the communication performed at the respective transmission and reception unit with respect to the maximum communicable time defined between the base station 10 and the terminal 20.

In Step S12, the base station 10 determines whether switching of the channel is performed. When it is determined in Step S12 that the switching of the channel is to be performed, the process transitions to Step S13. When it is determined in Step S12 that the switching of the channel is not performed, the process transitions to Step S16.

Here, the determination in Step S12 will be described. The base station 10 determines whether the switching of the channel can be performed when any one of the following conditions 1), 2), and 3) is satisfied. It is assumed that the priority order of the conditions 1), 2), and 3) is, for example, this order. The threshold values of the RSSIs in 1) and 2) may be the same values or different values. The RSSI to be compared to the threshold value may be a minimum value, an average value, or a median value within a predetermined period. In addition, the RSSI to be compared to the threshold value may be a variation amount from the threshold value.

1) The RSSIs for all channels are lower than the threshold value
2) The RSSIs for some channels are lower than the threshold value
3) The throughput in the currently used channel is lower than the threshold value
Regarding 1), when the RSSIs for all the channels are lower than the threshold value, the factor of the decrease in the RSSIs is considered to be caused by the unstable propagation environment such as communication to the non-line of sight region, communication when there is a shielding object, and long-distance communication. In this case, in order to increase the success probability of communication, the base station 10 determines whether switching to a radio device that handles a channel in a low frequency band, in which more stable communication is possible, can be performed. For example, when the radio devices are only the radio device 101 and the radio device 102, the base station 10 determines whether switching to the radio device 101 that handles the channel in a lower frequency band can be performed.

Regarding 2), when only the RSSIs of some channels are lower than the threshold value, the factor of the decrease in the RSSIs is considered specific to the channels. In this case, the base station 10 determines whether switching to a radio device that handles the remaining channels except for the channels can be performed. For example, when only the RSSI of the channel in the 2.4 GHz band is lower than the threshold value, the base station 10 determines whether switching to the radio device 102 can be performed. Conversely, when only the RSSI of the channel in the 5 GHz band is lower than the threshold value, the base station 10 determines whether switching to the radio device 101 can be performed.

Regarding 3), the throughput may be estimated from the RSSI, for example. As a method of estimating the throughput from the RSSI, for example, a method disclosed in Tomotsugu HASEGAWA et al, “Relations of RSSI and Average Throughput of IEEE802.11n Wireless LAN System”, Information Processing Society of Japan, Vol. 52, No. 9, pp. 2829-2840 (September 2011) may be used. When the throughput is lower than the threshold value, the base station 10 determines whether switching to a radio device that handles a channel in a high frequency band, in which communication of a large capacity is possible, can be performed. For example, when the radio devices are only the radio device 101 and the radio device 102, the base station 10 determines whether switching to the radio device 102 that handles the channel in a higher frequency band can be performed.

The determination of whether the switching of the channel can be performed is made based on the usage of the channel. The base station 10 searches for a channel having an RSSI exceeding the noise floor among switching destination channels, based on the RSSI. The base station 10 selects a free channel as a candidate for the switching destination channel from the usage of the searched channel. For example, it is assumed that each communication is required to be performed between the base station 10 and the terminal 20 in a communication time within 10% of the total communicable time. In this case, the base station 10 determines that there is a free channel having usage which is within 90% of the total communicable time. After determining the free channel, the base station 10 selects a channel having the highest throughput among the free channels, as a candidate for the switching destination channel. After selecting the candidate for the switching destination channel, the base station 10 compares the throughput in a switching source channel with the throughput in the candidate switching destination channel. If the throughput in the candidate switching destination channel is higher than the throughput in the switching source channel, the base station 10 determines that switching to the candidate switching destination channel can be performed.

Here, the description returns to FIG. 6. In Step S13 when it is determined in Step S12 that the switching of the channel is to be performed, the base station 10 transmits a channel switching request to the terminal 20 using the switching source channel. The channel switching request is transmitted by using a radio device that handles the switching source channel.

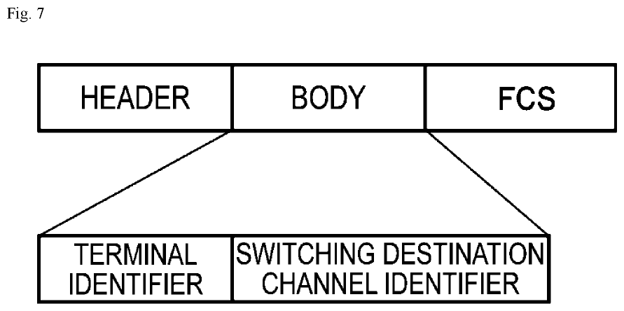

FIG. 7 is a diagram illustrating an example of a MAC frame format of the channel switching request. As illustrated in FIG. 7, the channel switching request includes a header, a body, and a frame check sequence (FCS). The header is a MAC header generated by the processing of the second layer. The FCS is an error detection code for data error detection. The error detection code may be a cyclic redundancy check (CRC) code. The body is a portion of entity data of the channel switching request. The body includes, for example, a terminal identifier and a switching destination channel identifier. The terminal identifier is an identifier for identifying the terminal 20, and is, for example, a MAC address of the terminal 20. The terminal identifier may include a plurality of terminal identifiers for identifying a plurality of terminals. The terminal 20 recognizes that the channel switching request is addressed to the terminal 20, from the terminal identifier. The switching destination channel identifier is an identifier for identifying the switching destination channel in the terminal 20.

Here, the description returns to FIG. 6. In Step S14, the base station 10 determines whether a Request Accepted response has been received from the terminal 20. As described later, the terminal 20 that has received the channel switching request determines whether the channel may be switched. When the channel is switched, the terminal 20 transmits a Request Accepted response to the base station 10. When it is not required to switch the channel, the terminal 20 transmits a Request Rejected response to the base station 10. When it is determined in Step S14 that the Request Accepted response has been received from the terminal 20, the process transitions to Step S15. When it is determined in Step S14 that the Request Rejected response has been received from the terminal 20, the process transitions to Step S16. In this case, the switching of the channel is not performed.

In Step S15, the base station 10 performs switching of the channel. The base station 10 switches the radio device by the switching unit 105. Then, the processing transitions to Step S16.

In Step S16, the base station 10 determines whether to transmit or receive a radio signal. For example, when data is input from the server 30, it is determined to transmit a radio signal. In addition, when the radio signal has been received from the antenna 1012 or 1022, it is determined to receive the radio signal. When it is determined in Step S16 that the radio signal is transmitted or received, the process transitions to Step S17. When it is determined in Step S16 that the radio signal is not transmitted or received, the processing of FIG. 6 is ended.

In Step S17, the base station 10 transmits or receives a radio signal. Then, the processing of FIG. 6 is ended. When the switching of the channel is performed, the base station 10 performs transmission or reception by using the switched channel.

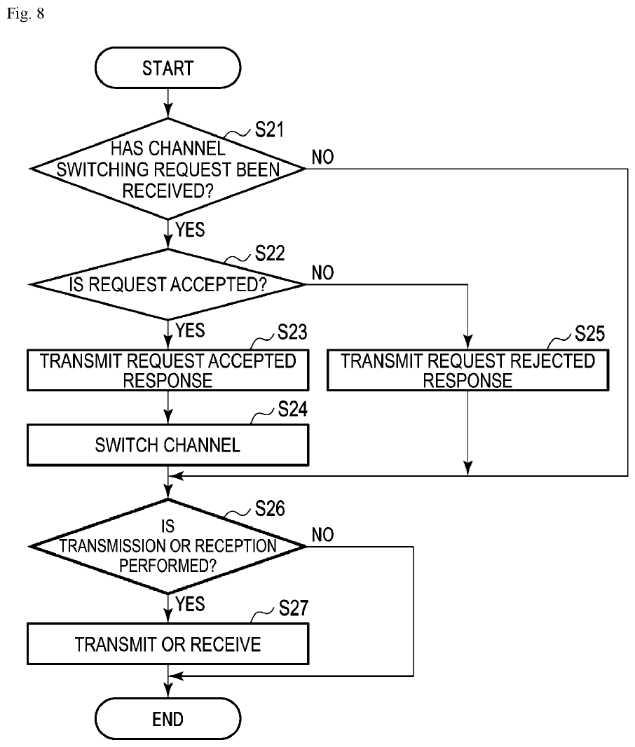

Next, an operation of the terminal 20 will be described. FIG. 8 is a flowchart illustrating an example of the operation of the terminal 20. In Step S21, the terminal 20 determines whether a channel switching request addressed to the terminal 20 has been received. In Step S21, when it is determined that the channel switching request has been received, the process transitions to Step S22. When it is determined in Step S21 that the channel switching request has not been received, the process transitions to Step S26.

In Step S22, the terminal 20 determines whether switching of a channel can be performed, that is, whether the request of switching of the channel is accepted, based on the received channel switching request. When it is determined in Step S22 that the request of switching of the channel is accepted, the process transitions to Step S23. In Step S22, when it is determined that it is not possible to perform the switching of the channel, that is, the request of switching is rejected, for example, when a specific channel needs to be used for a request and the like from the application soft, the process transitions to Step S25. The terminal 20 may not determine whether the request of switching of the channel is accepted. In this case, the processes of Steps S22, S23, and S25 may be omitted.

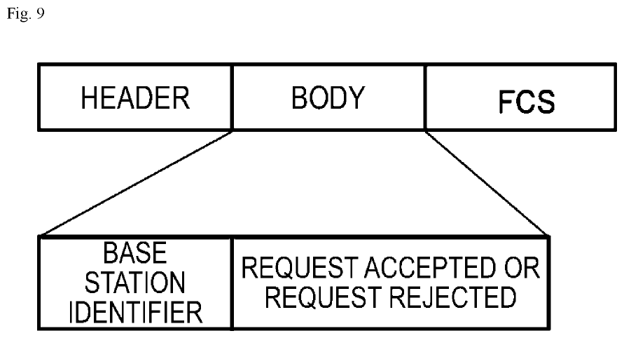

In Step S23, the terminal 20 transmits a response indicating that the request of switching is accepted, to the base station 10. In Step S25, the terminal 20 transmits a response indicating that the request of switching is rejected, to the base station 10. FIG. 9 is a diagram illustrating an example of a MAC frame format of the Request Accepted response or the Request Rejected response. As illustrated in FIG. 9, the channel switching request includes a header, a body, and an FCS. The header and the FCS may be similar to FIG. 7. The body includes, for example, a base station identifier, and a Request Accepted flag or a Request Rejected flag. The base station identifier is an identifier for identifying the base station 10, and is, for example, a MAC address of the base station 10. The base station 10 recognizes that the response is addressed to the base station 10 from the base station identifier. The Request Accepted flag or the Request Rejected flag is a flag indicating that the request of switching is accepted or rejected.

In Step S24, the terminal 20 performs switching of the channel. The terminal 20 stores the switching destination channel identifier included in the channel switching request, in the channel information storage unit 204. The terminal 20 switches the radio device by the switching unit 205. Then, the processing transitions to Step S26.

In Step S26, the terminal 20 determines whether to transmit or receive a radio signal. For example, when a MAC frame is input from the MAC processing unit 203, it is determined to transmit a radio signal. When the radio signal has been received from the antenna 2012 or 2022, it is determined to receive the radio signal. When it is determined in Step S26 that the radio signal is transmitted or received, the process transitions to Step S27. When it is determined in Step S26 that the radio signal is not transmitted or received, the processing of FIG. 8 is ended.

In Step S27, the terminal 20 transmits or receives a radio signal. Thereafter, the processing of FIG. 8 is ended. When the switching of the channel is performed, the terminal 20 performs transmission or reception by using the switched channel.

As described above, according to the embodiment, in communication between the base station and the terminal, in which a plurality of channels are available, the switching of the channel is performed in accordance with the RSSI indicating the communication status and the usage of the channel. Thus, when the propagation environment is not stable, switching to a channel in a low frequency band is performed, so that stable communication may be performed. In addition, when the throughput is required, switching to a channel in a high frequency band is performed, so that communication of a large capacity can be performed. Thus, improvement of the throughput is expected.

### First Modification Example

Hereinafter, modification examples of the embodiment will be described. In the above-described embodiment, the base station 10 acquires radio information and performs switching of a channel. When the terminal 20 includes the radio information acquisition unit and the determination unit, the terminal 20 may acquire the radio information and perform switching of the channel.

### Second Modified Embodiment

In the embodiment, each radio device is configured to transmit and receive radio signals by using channels in different frequency bands. The radio device may be configured to transmit and receive radio signals by using different channels in the same frequency band. For example, one radio device may be configured to transmit a radio signal by using a first channel in the 2.4 GHz band, and another radio device may be configured to transmit a radio signal by using a second channel in the 2.4 GHz band. The first channel and the second channel in this case may each include a plurality of channels as long as the first channel and the second channel do not overlap each other.

### Other Modified Examples

The processing in the aforementioned embodiment can also be stored as a program that a CPU being a computer, and the like can be caused to execute. In addition, the processing can be stored and distributed in a storage medium of an external storage device such as a magnetic disk, an optical disc, or a semiconductor memory. Then, the CPU and the like can execute the aforementioned processing by reading the program stored in the storage medium of the external storage device and by the read program controlling operations.

Note that the present disclosure is not limited to the above-mentioned embodiment but can be variously modified in the implementation stage without departing from the gist of the present disclosure. In addition, an appropriate combination of embodiments can also be implemented, in which a combination of their effects can be obtained. Further, the above-mentioned embodiment includes various disclosures, which can be designed by combining constituent elements selected from a plurality of constituent elements disclosed here. For example, a configuration in which some constituent elements are removed from all the constituent elements illustrated in the embodiment can be designed as a disclosure if the problems can be solved and the effects can be achieved.

### REFERENCE SIGNS LIST

1 . . . Radio system

10 . . . Base station

### 11 . . . CPU

### 12 . . . ROM

### 13 . . . RAM

14 . . . Radio communication module
15 . . . Wired communication module

### 20 . . . Terminal

### 21 . . . CPU

### 22 . . . ROM

### 23 . . . RAM

24 . . . Radio communication module

### 25 . . . Display

### 26 . . . Storage

### 30 . . . Server

101, 102 . . . Radio device
103 . . . MAC processing unit
104 . . . Determination unit
105 . . . Switching unit
201, 202 . . . Radio device
203 . . . MAC processing unit
204 . . . Channel information storage unit
205 . . . Switching unit
1011, 1021 . . . Transmission and reception unit

### 1012, 1022 . . . Antenna

1013, 1023 . . . radio information acquisition unit
2011, 2021 . . . Transmission and reception unit

### 2012, 2022 . . . Antenna

1. A radio communication apparatus comprising:
a first radio communication unit configured to transmit a radio signal by using a first channel;
a second radio communication unit configured to transmit a radio signal by using a second channel different from the first channel;
a first radio information acquisition unit configured to acquire first radio information containing received signal strength in the first radio communication unit and usage of the first channel;
a second radio information acquisition unit configured to acquire second radio information containing received signal strength in the second radio communication unit and usage of the second channel;
a determination unit configured to determine whether to switch between the first radio communication unit and the second radio communication unit in accordance with the first radio information and the second radio information; and
a switching unit configured to switch between the first radio communication unit and the second radio communication unit in accordance with a result of determination by the determination unit.

2. The radio communication apparatus according to claim 1, wherein
when both the received signal strength of the first radio communication unit and the received signal strength of the second radio communication unit are lower than a threshold value, the determination unit determines whether to switch to the radio communication unit using a channel in a lower frequency band between the first radio communication unit and the second radio communication unit.

3. The radio communication apparatus according to claim 1, wherein
when either the received signal strength of the first radio communication unit or the received signal strength of the second radio communication unit is lower than a threshold value, the determination unit determines whether to switch to a remaining radio communication unit.

4. The radio communication apparatus according to claim 1, wherein
the determination unit calculates a throughput of a radio communication unit in use in accordance with the received signal strength of the radio communication unit in use between the first radio communication unit and the second radio communication unit, and determines, when the throughput calculated is lower than a threshold value, whether to switch to the radio communication unit using a channel in a higher frequency band than that of the radio communication unit in use.

5. The radio communication apparatus according to claim 1, wherein
the determination unit determines the available radio communication unit among radio communication units to be determined whether to switch in accordance with usage of the radio communication units to be determined whether to switch, estimates a throughput of the available radio communication unit in accordance with received signal strength of the available radio communication unit, and determines whether to switch in accordance with the throughput estimated.

6. A radio communication method comprising:
by a first radio communication unit, transmitting a radio signal by using a first channel;
by a second radio communication unit, transmitting a radio signal by using a second channel different from the first channel;
acquiring first radio information containing received signal strength in the first radio communication unit and usage of the first channel;
acquiring second radio information containing received signal strength in the second radio communication unit and usage of the second channel;
determining whether to switch between the first channel and the second channel in accordance with the first radio information and the second radio information; and
switching between the first channel and the second channel in accordance with a result by the determining.
